(19) United States
(12) Patent Application Publication
(10) Pub. No.: US 2003/0210692 A1
(43) Pub. Date: Nov. 13, 2003

(54) Method and apparatus for providing data service selection in a packet data communication system

(76) Inventors: Shreesha Ramanna, Vernon Hills, IL (US); Jay Jayapalan, Buffalo Grove, IL (US); Anda M. Farcasanu, Glenview, IL (US)

Correspondence Address: MOTOROLA, INC., 1303 EAST ALGONQUIN ROAD, IL01/3RD, SCHAUMBURG, IL, 60196

(21) Appl. No.: 10/431,602

(22) Filed: May 7, 2003

Related U.S. Application Data
(60) Provisional application No. 60/379,923, filed on May 13, 2002.

(51) Int. Cl. H04L 12/28

(52) U.S. Cl. 370/389

(57) ABSTRACT

A packet data communication system that includes an infrastructure in wireless communication with a mobile station provides a data service selection to a user of a mobile station. The infrastructure receives packet data intended for the mobile station, wherein the data packet comprises information concerning a domain sourcing the packet data and an intended destination of the packet data. The infrastructure then conveys the domain information to the mobile station, wherein the domain information allows the mobile station to determine whether to receive the packet data or to activate a packet data service.

### REFERENCE(S) TO RELATED APPLICATION(S)

The present application claims priority from provisional application, Serial No. 60/379,923, entitled “METHOD AND APPARATUS FOR PROVIDING DATA SERVICE SELECTION IN A PACKET DATA COMMUNICATION SYSTEM,” filed May 13, 2002, which is commonly owned and incorporated herein by reference in its entirety.

### FIELD OF THE INVENTION

The present invention relates generally to cellular communication systems, and, in particular, to data transmission protocols in a packet data communication system.

### BACKGROUND OF THE INVENTION

Wireless packet data communication systems currently include “Push,” or “Always On,” capabilities. In a “Push,” or “Always On,” scheme, a wireless network operator pushes information from a content provider, such as an Internet Service Provider (ISP) or an operator of a web site, to a mobile station (MS). The pushing of information to the MS involves a conveyance of data to the MS without the intervention of a user of the MS. Typically, in order to optimize resource allocation and minimize operating costs, a wireless network operator will release air and network resources allocated to an MS after registering the MS with the network. When the network operator then wants to push information to the MS, the network first pages the MS for subsequent transmittal of data and to allow a dormant MS to self-activate. The network operator then transfers the data without the intervention of a user of the MS.

The transfer of data to the MS without the intervention of the user may pose a problem to the user. First, users are typically charged for every data packet transmitted to the MS, regardless of whether the data packet was transmitted to the MS with the user's knowledge. Second, the reception of pushed data by an MS engaged in an active communication session may cause an interruption of the session, which some users may also find undesirable. Therefore, a need exists for a method and apparatus that provides a user of an MS with the capability to dynamically select the data services provided to the MS.

### BRIEF DESCRIPTION OF THE DRAWINGS

FIG. 1 is a block diagram of a wireless communication system in accordance with an embodiment of the present invention.

FIG. 2 is a signal flow diagram of a process performed by the communication system of FIG. 1 in providing a mobile station with data packets sourced by an external network in accordance with an embodiment of the present invention.

FIG. 3 is a signal flow diagram of a process performed by the communication system of FIG. 1 in providing a mobile station with data packets sourced by an external network in accordance with another embodiment of the present invention.

### DETAILED DESCRIPTION OF THE INVENTION

To address the need for a method and an apparatus that provides a user of a mobile station (MS) with the capability to dynamically select the data services provided to the MS, a packet data communication system that includes an infrastructure in wireless communication with a mobile station provides a data service selection to a user of a mobile station. The infrastructure receives packet data intended for the mobile station, wherein the data packet comprises information concerning a domain sourcing the packet data and an intended destination of the packet data. The infrastructure then conveys the domain information to the mobile station, wherein the domain information allows the mobile station to determine whether to receive the packet data or to activate a packet data service.

Generally, an embodiment of the present invention encompasses a method for providing a data service selection to a user of a mobile station in a packet data communication system. The method comprises a step of receiving packet data intended for the mobile station, wherein the data packet comprises information concerning a domain sourcing the packet data and an intended destination of the packet data. The method further comprises a step of conveying the domain information to the mobile station, wherein the domain information allows the mobile station to determine whether to receive the packet data.

Another embodiment of the present invention encompasses a method for providing a data service selection to a user of a mobile station in a packet data communication system. The method comprises a step of receiving packet data intended for the mobile station, wherein the data packet comprises information concerning a domain sourcing the packet data and an intended destination of the packet data. The method further comprises a step of conveying the domain information to the mobile station, wherein the domain information allows the mobile station to determine whether to activate a packet data service.

Still another embodiment of the present invention encompasses a method for providing a data service selection to a user of a mobile station in a packet data communication system. The method comprises steps of receiving packet data intended for the mobile station, determining a domain sourcing the packet data based on a data path over which the packet data was received, and determining an intended destination of the packet data. The method further comprises a step of conveying information concerning the domain sourcing the packet data to the mobile station, wherein the domain information allows the mobile station to determine whether to activate a packet data service.

Yet another embodiment of the present invention encompasses a Packet Data Service Node (PDSN) capable of operating in a packet data communication system that includes an infrastructure that provides wireless communication services to at least one mobile station, wherein the infrastructure is capable of receiving packet data from a network domain that is intended for the at least one mobile station. The PDSN is further capable of assembling an A11 domain identification message, wherein the A11 domain identification message includes information identifying the domain sourcing the packet data to the infrastructure and further identifying the intended destination of the packet data.

Still another embodiment of the present invention encompasses a Packet Control Function (PCF) capable of operating in a packet data communication system that includes an infrastructure that provides wireless communication services to at least one mobile station, wherein the infrastructure is capable of receiving packet data from an external network that is intended for the at least one mobile station. The PCF is further capable of assembling an A9 domain identification message, wherein the A9 domain identification message includes information identifying the domain sourcing the packet data to the infrastructure and further identifying the intended destination of the packet data.

Yet another embodiment of the present invention encompasses a Base Station Controller (BSC) capable of operating in a packet data communication system that includes an infrastructure that provides wireless communication services to at least one mobile station, wherein the infrastructure is capable of receiving packet data from a network domain that is intended for the at least one mobile station. The BSC is further capable of assembling an A1 domain identification message, wherein the A1 domain identification message includes information identifying the domain sourcing the packet data to the infrastructure and further identifying the intended destination of the packet data.

Still another embodiment of the present invention encompasses a Base Station Controller (BSC) capable of operating in a packet data communication system that includes an infrastructure that provides wireless communication services to at least one mobile station, wherein the infrastructure is capable of receiving packet data from a network domain that is intended for the at least one mobile station. The BSC is further capable of assembling a domain and destination identification message for wireless transmission to a mobile station, wherein the domain and destination identification message includes information identifying the domain sourcing the packet data to the infrastructure and further identifying the intended destination of the packet data and wherein the domain and destination identification message is utilized by the mobile station to determine whether to receive the packet data.

Yet another embodiment of the present invention encompasses a Mobile Switching Center (MSC) capable of operating in a packet data communication system comprising an infrastructure that provides wireless communication services to at least one mobile station, wherein the infrastructure is capable of receiving packet data from a network domain that is intended for the at least one mobile station. The MSC is further capable of assembling an A1 domain identification message, wherein the A1 domain identification message includes information identifying the domain sourcing the packet data to the infrastructure and further identifying the intended destination of the packet data.

Still another embodiment of the present invention encompasses a Base Station Controller (BSC) capable of operating in a packet data communication system comprising an infrastructure that provides wireless communication services to a mobile station, wherein the infrastructure is capable of receiving packet data from a network domain that is intended for the mobile station. The BSC is further capable of assembling a message requesting additional services for the mobile station when the mobile station is engaged in a communication session, wherein the additional services request includes a request for provision of a service to the mobile station that facilitates a transfer of the packet data to the mobile station and further includes information identifying the domain sourcing the packet data to the infrastructure and the intended destination of the packet data.

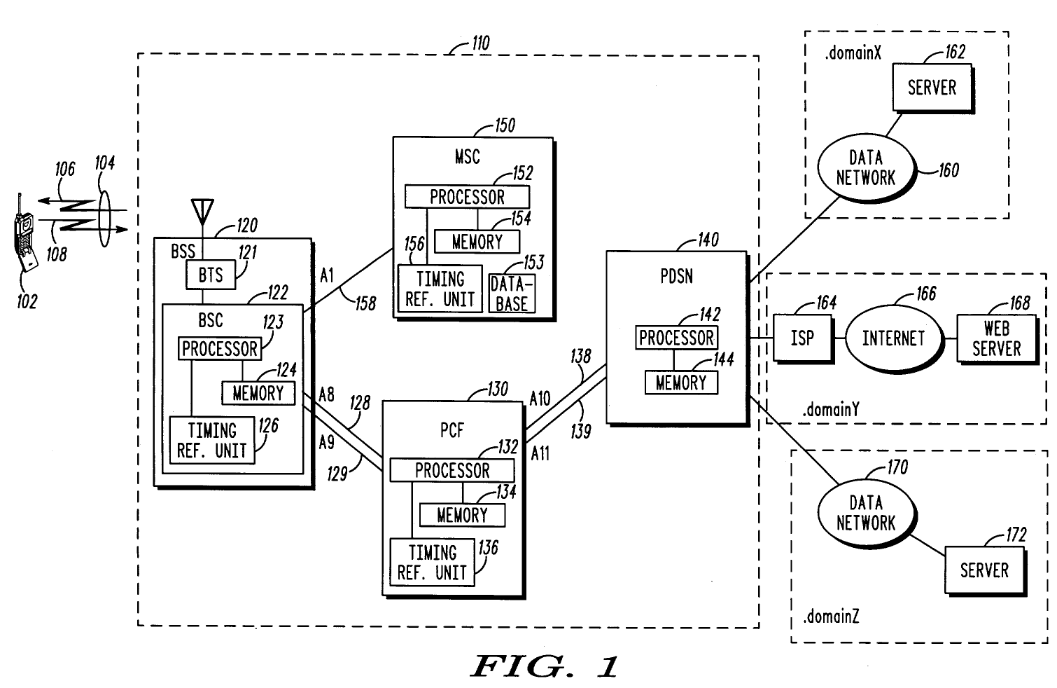

The present invention may be more fully described with reference to FIGS. 1-3. FIG. 1 is a block diagram of a wireless communication system 100 in accordance with an embodiment of the present invention. Communication system 100 includes at least one mobile station (MS) 102, such as a cellular telephone, a radiotelephone, or a wireless modem, and a base station subsystem (BS) 120 that communicates with MS 102 via an air interface 104 that includes a forward link 106 and a reverse link 108. BSS 120 preferably includes at least one base transceiver station (BTS) 121 operably coupled to a base station controller (BSC) 122.

BS 120, preferably BSC 122 of BS 120, is operably coupled to each of a Packet Control Function (PCF) 130 and a Mobile Switching Center (MSC) 150. PCF 130 is, in turn, operably coupled to a Packet Data Service Node (PDSN) 140. BS 120, PCF 130, PDSN 140, and MSC 150 are collectively referred to herein as a telecommunications infrastructure 110. Each of BSC 122, PCF 130, PDSN 140, and MSC 150 includes a respective processor 123, 132, 142, and 152, such as one or more microprocessors, microcontrollers, digital signal processors (DSPs), combinations thereof or such other devices known to those having ordinary skill in the art, and one or more associated memory devices 124, 134, 144, and 154, such as random access memory (RAM), dynamic random access memory (DRAM), and/or read only memory (ROM) or equivalents thereof, that store data and programs that may be executed by the corresponding processor. In addition, each of BSC 122, PCF 130, and MSC 150 further includes a respective timing reference unit 126, 136, and 156 that is coupled to a respective processor 123, 132, and 152.

Telecommunications infrastructure 110, preferably PDSN 140, is operably coupled to at least one external network domain that provides data to the infrastructure that is to be “pushed” to MS 102. For example, infrastructure 110 may be operably coupled to a first network domain, ‘.domainX,’ such as an electronic mail (email) domain, that comprises a first data network 160 operably coupled to an email server 162. Infrastructure 110 may be further coupled to a second network domain, ‘.domainY,’ such as the Internet, that includes an ISP 164 that provides access to the Internet 166 for MS 102 and a web server 168 that provides a “push” information service subscribed to by a customer associated with MS 102. For example, the “push” information service may comprise a sports update service, a business news service, or a stock quote service, that is subscribed to by a customer associated with MS 102 and that periodically conveys information updates to MS 102. Infrastructure 110 may be further coupled to a third network domain, ‘.domainZ,’ such as a corporate domain that is associated with an employer of a user of MS 102, and includes a data network 170 operably coupled to a push server 172. Domains ‘.domainX,’ ‘.domainY,’ and ‘.domainZ,’ are include herein for the purpose of illustrating the principles of the present invention and are not intended to limit the invention in any way.

Communication system 100 comprises a wireless packet data communication system. In order for MS 102 to establish a packet data connection with a network domain such as the network domains ‘.domainX,’ ‘.domainY,’ and ‘.domainZ,’ each of BS 120, PCF 130, PDSN 140, and MSC 150 operates in accordance with well-known wireless telecommunications protocols. By operating in accordance with well-known protocols, a user of MS 102 can be assured that MS 102 will be able to communicate with infrastructure 110 and establish a packet data communication link with an external network via infrastructure 110. Preferably, communication system 100 operates in accordance with the 3GPP2 and TIA/EIA (Telecommunications Industry Association/Electronic Industries Association) IS-2001, or IOS (Inter Operability Specification), standard, which provides a compatibility standard for IS-2000, that is, cdma2000, 1xEV-DO, or 1xEV-DV systems, and infrastructure 110 comprises an access network that supports IS-2001 compliant interfaces. The standard specifies wireless telecommunications system operating protocols, including radio system parameters and call processing procedures. However, those who are of ordinary skill in the art realize that communication system 100 may operate in accordance with any one of a variety of wireless packet data communication systems, such as a Global System for Mobile communication (GSM) communication system, a WCDMA-based UMTS system, a Time Division Multiple Access (TDMA) communication system, a Frequency Division Multiple Access (FDMA) communication system, or an Orthogonal Frequency Division Multiple Access (OFDM) communication system.

BSC 122 and MSC 150 are coupled by an A1 interface 158 over which they exchange A1 messages. The A1 messages are assembled in each of BSC 122 and MSC 150 by their respective processors 123, 152 and pursuant to software stored in their respective memory devices 124, 154. BSC 122 and PCF 130 are coupled by an A8/A9 interface 128, 129 over which they exchange A8/A9 messages. A8/A9 interface 128, 129 includes an A8 interface 128 that provides a bearer path between the BSC and the PCF and an A9 signaling interface 129. The A8/A9 messages are assembled in each of BSC 122 and PCF 130 by their respective processors 123, 132 and pursuant to software stored in their respective memory devices 124, 134. PCF 130 and PDSN 140 are coupled by an A10/A11 interface 138, 139 over which they exchange A10/A11 messages. A10/A11interface 138, 139 includes an A10 interface 138 that provides a bearer path between the PCF and the PDSN and an A11 signaling interface 139. The A10/A11 messages are assembled in each of PCF 130 and PDSN 140 by their respective processors 132, 142 and pursuant to software stored in their respective memory devices 134, 144.

In order to provide a user of MS 102 with the capability to dynamically select the data services provided to the MS, communication system 100 provides an MS that is registered with the system, that is, MS 102, with information related to the domain sourcing the data to the MS. Based on the domain information, the user is then able to determine whether to activate a data service and/or receive the data packets. By allowing the user to determine whether to receive the data packets, the user can control a degree to which the user is interrupted during an active communication session. In addition, a user of a mobile station, such as MS 102, is typically billed by a provider of wireless communication services, such as an operator of infrastructure 110, for data services on a basis of the quantity of data transmitted to and from the device. By allowing the user to determine whether to receive the data packets, the user is better able to control his or her cost of wireless service.

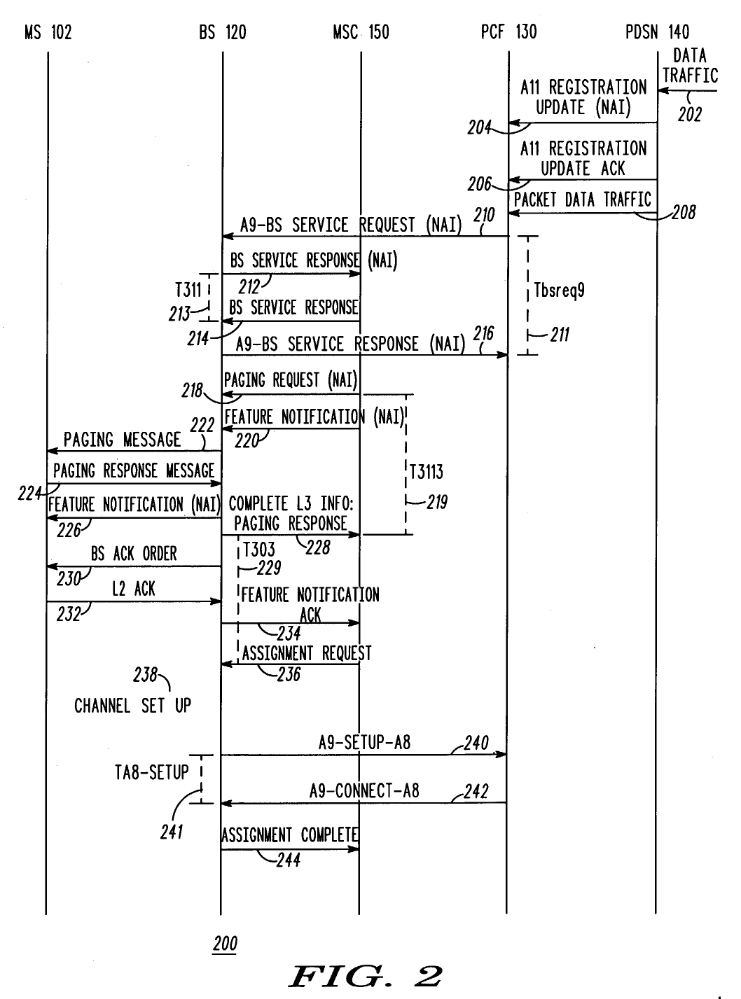

In one embodiment of the present invention, a “single session” embodiment, MS 102 is dormant, or is not otherwise engaged in an active data transfer, at the time that infrastructure 110 receives data packets to “push” to the MS. As a result, communication system 100 must reactivate the MS and establish a data communication path with the MS in order to provide a packet data service to the MS. FIG. 2 is a signal flow diagram 200 illustrating a process performed by communication system 100, and in particular by infrastructure 110, in providing MS 102 with data packets received by the infrastructure from an external network in accordance with the “single session” embodiment. Signal flow diagram 200 begins when infrastructure 110, and in particular PDSN 140, receives (202) data packets from a network domain. The data packets are conveyed to infrastructure 110 in order that the infrastructure may “push” the data to MS 102. The data packets may include information identifying the network domain sourcing the data to the infrastructure, such as the identifiers ‘.domainX,’ ‘.domainY,’ and ‘.domainZ.’ PDSN 140 may also discern the source of the data based on the data path or tunnel on which the data packets arrived.

In response to receiving the data packets from the network domain, PDSN 140, preferably processor 142, assembles an A11 domain identification message and conveys (204) the message to PCF 130 via A11 interface 139. PDSN 140 also forwards (208) the data packets received from the external network to PCF 130 via an existing point-to-point protocol (PPP) connection and an A10/A11 connection associated with MS 102 for packet data service. The A11 domain identification message identifies the domain sourcing the data packets received by the PDSN and further identifies the intended destination of the data packets. Preferably, the A11 domain identification message is a modified A11-Registration Update message that processor 142 modifies by embedding in the message a Network Access Identifier (NAI) that identifies the domain sourcing the data packets and the intended destination of the data packets. For example, an identifier such as ‘user@domain’ may be added to the message, wherein ‘user’ corresponds to an identifier, such as a routing address, associated with a destination of the data packets, that is, MS 102, and ‘domain’ is an identifier that corresponds to the domain sourcing the data packets to infrastructure 110, such as ‘.domainX,’ ‘.domainY,’ or ‘.domainZ.’

In response to receiving the A11 domain identification message, PCF 130 acknowledges the message by conveying (206) an acknowledgment to PDSN 140 via A11 interface 139. Preferably the acknowledgment comprises an A11-Registration Update Ack message. In addition, in response to receiving the A11 domain identification message, PCF 130, preferably processor 132, assembles and conveys (210) an A9 domain identification message to BS 120, preferably BSC 122, via A9 interface 129. Based on the A11 domain identification message, the A9 domain identification message includes information identifying the domain sourcing the data packets and further identifying the intended destination of the data packets. Preferably, the A9 domain identification message is an A9-BS Service Request message that processor 132 modifies by embedding in the message the NAI information received from PDSN 140. When PCF 130 conveys the A9 domain identification message to BS 120, the PCF, in particular processor 132, also starts a first timer, T_{bsreq9}, that measures a first time period (211) with reference to timing reference unit 136.

In response to receiving the A9 domain identification message, BS 120, preferably processor 123 of BSC 122, assembles and conveys (212) a first A1 domain identification message to MSC 150 via A1 interface 158. Based on the A9 domain identification message, the first A1 domain identification message includes information on the domain sourcing the data packets and the intended destination of the data packets. Preferably, the first A1 domain identification message is a BS Service Request message that processor 123 modifies by embedding in the message the NAI information received from PCF 130. When BS 120 conveys the first A1 domain identification message to MSC 150, the BS, preferably BSC 122 and in particular processor 123, also starts a second timer, T₃₁₁ , that measures a second time period (213) with reference to timing reference unit 126.

When MSC 150 receives the first A1 domain identification message, the MSC acknowledges the message by conveying (214) an acknowledgment, preferably a BS Service Response message, to BS 120 via A1 interface 158. Upon receiving the acknowledgment from MSC 150, BS 120, preferably BSC 122, stops (213) timer T₃₁₁and acknowledges (216) receipt of the A9 domain identification message by conveying an A9 acknowledgment to PCF 130 via A9 interface 129. Preferably the A9 acknowledgment conveyed by BS 120 to PCF 130 comprises an A9-BS Service Response message. When the second time period (213), as measured by second timer T₃₁₁, expires without BS 120 receiving an A9 acknowledgment of the first A1 domain identification message, BS 120, preferably BSC 122, reconveys the first A1 domain identification message to MSC 150, restarts timer T₃₁₁, and again awaits receipt of an A9 acknowledgment within a second time period (213). Upon receiving the A9 acknowledgment from BS 120, PCF 130 stops first timer T_{bsreq9}. When the first time period (211), as measured by first timer T_{bsreq9}, expires without PCF 130 receiving an acknowledgment of the A9 domain identification message sent to BS 120, PCF 130 reconveys the A9 domain identification message to the BS and steps (212), (213), (214), and (216) are repeated by system 100.

In addition, in response to receiving the first A1 domain identification message, MSC 150 conveys (218) to BS 120 a request that the BS page MS 102. MSC 150, preferably processor 152, also assembles and conveys (220) to the BS a second A1 domain identification message that includes information concerning the domain sourcing the data packets to infrastructure 110 and further identifying the destination of the data packets. However, in another embodiment of the present invention, BS 120 does not convey to MSC 150, nor does MSC 150 convey to BS 120, information concerning the domain sourcing the data packets to infrastructure 110 and further identifying the destination of the data packets.

Preferably, the paging request comprises a Paging Request message that requests that BS 120 page MS 102 in order to initiate a packet data call with the MS. In one embodiment of the present invention, the Paging Request message also comprises the second A1 domain identification message, wherein processor 152 modifies the Paging Request message by embedding information, preferably the NAI information received by MSC 150 from BS 120, identifying the domain sourcing the data packets to infrastructure 110 and further identifying the destination of the data packets. In another embodiment of the present invention, the second A1 domain identification message comprises a modified first Feature Notification message, wherein processor 152 modifies a Feature Notification message by embedding in the message the domain and destination information, again preferably the NAI information received by MSC 150 from BS 120. Typically, Feature Notification is used to indicate DISPLAY characters, called and caller numbers, message-waiting notifications, and alert indications. Upon conveying the paging request to BS 120, MSC 150, preferably processor 152, starts a third timer, T₃₁₁₃, that measures a third time period (219) with reference to timing reference unit 156.

When BS 120 receives the paging request from MSC 150, the BS pages (222) MS 102 via a paging channel included in forward link 106. Preferably, BS 120 pages MS 102 by transmitting a Paging Message that includes an identifier associated with MS 102 that allows the MS to determine that the Paging Message is intended for the MS. Upon receiving the Paging Message and determining that the Paging Message was intended for itself, MS 102 acknowledges (224) the Paging Message to BS 120, preferably by transmitting a first Paging Response Message, via an access channel included in reverse link 108.

When BS 120 receives the page acknowledgment from MS 102, the BS transmits (226), to the MS, an air interface message comprising information concerning the domain sourcing the data packets to infrastructure 110 and further identifying the destination of the data packets, that is, MS 102. In one embodiment of the present invention, BS 120 transmits the domain and destination information to MS 102 by forwarding the modified first Feature Notification message received by the BS from MSC 150. In another embodiment of the present invention, BS 120 transmits the domain and destination information to MS 102 in a modified second Feature Notification message. In the latter embodiment, processor 123 of BSC 122 assembles a second Feature Notification message and modifies the message by embedding information, preferably the NAI information received by BS 120 from MSC 150 or from PCF 130, identifying the domain sourcing the data packets to infrastructure 110 and the destination of the data packets. In addition, in response to receiving the first Paging Response Message, BS 120, preferably BSC 122, informs (228) MSC 150 that the BS has successfully paged MS 102 and acknowledges (230), to MS 102, receipt of the message. Preferably, BS 120 acknowledges receipt of the first Paging Response Message by transmitting a BS Ack Order message to MS 102. BS 120, preferably processor 123 of BSC 122, also starts a fourth timer, T₃₀₃, that measures a fourth time period (229) with reference to timing reference unit 126.

Preferably, BS 120 informs MSC 150 of the successful paging of MS 102 by conveying a second Paging Response Message to MSC 150 via A1 interface 156. The second Paging Response Message is preferably included in a complete Layer 3 information message that is conveyed by BS 120 to MS 150. When MSC 150 fails to receive information concerning a successful page of MS 102 prior to expiration of the third time period (219), as measured by third timer T₃₁₁₃, the MSC reconveys the modified Paging Request and modified first Feature Notification to BS 120, restarts timer T3113, and again awaits information concerning a successful page of MS 102 before expiration of a third time period (219).

In one embodiment of the present invention, in response to receiving the domain and destination information, that is, the second modified Feature Notification message, MS 102 indicates to a user of the MS that infrastructure 110 has received data packets that are intended for the user and are from the domain identified by the message. For example, MS 102 may include a display upon which the MS displays a message for the user. The user of MS 102 can then indicate, for example by depressing a designated key on a keyboard included in the MS, whether the user desires to receive the data packets. In another embodiment of the present invention, the user of MS 102, upon activating the MS, may be presented with a menu of the services, that is, the domains, to which the user subscribes. The user may then input into MS 102, for example by depressing designated keys on the keyboard, the domains from which he desires to receive information, that is, data packets, and the domains from which he does not want to receive data packets. In yet another embodiment of the present invention, the user may have the option of getting notified before delivery, to the MS 102, of information included in data packets received by infrastructure 110 so that the user may choose to receive the information if desired.

By providing the user of MS 102 with the capability to dynamically select the data services that are provided to the MS, the user can control a degree to which the user is interrupted during an active communication session. In addition, a user of a mobile station, such as MS 102, is typically billed by a provider of wireless communication services, such as an operator of infrastructure 110, for data services on a basis of the quantity of data transmitted to and from the device. By providing the user with the capability to dynamically select the data services provided to the MS, the user is better able to control his or her cost of wireless service.

When the user indicates a desire to receive the data packets from the domain identified by the second modified Feature Notification message, MS 102, in response to the user's indication and further in response to receipt of the BS Ack Order message from BS 120, acknowledges (232) receipt of the second Feature Notification message to BS 120, preferably by use of a Layer 2 Acknowledgment. When the user fails to indicate a desire to receive the data packets, or indicates a desire to not receive the data packets, MS 102 does not acknowledge receipt of the second modified Feature Notification message or rejects the data reactivation attempt. When the fourth time period (229), as measured by fourth timer T₃₀₃, expires prior to BS 120 receiving an acknowledgment of the second Feature Notification message, the BS may either terminate the process of providing the data packets to MS 102 or retransmit the second modified Feature Notification message to MS 102 and restart fourth timer T₃₀₃. In the latter instance, after BS 120 retransmits the second modified Feature Notification message to MS 102 a predetermined number of times without receiving an acknowledgment prior to an expiration of a fourth time period (229), the BS terminates the process of providing the data packets to MS 102.

In response to receiving an acknowledgment of the second modified Feature Notification acknowledgment from MS 102, BS 120 acknowledges (234), to MSC 150, receipt of the first Feature Notification message received by the BS from MSC 150. Preferably, BS 120 acknowledges the first Feature Notification message by conveying a Feature Notification Acknowledgment message to MSC 150. Meanwhile, in response to receiving the Paging Response message from BS 120, MSC 150 assembles and conveys (236) a request for a channel assignment to BS 120. Preferably, the request for a channel assignment comprises an Assignment Request message and requests an assignment, by BS 120, of a communication link between PCF 130 and MS 102, that is, an assignment of a traffic channel in forward channel 106 and an A8 connection in A8 interface 128 in order to establish a communication link between PCF 130 and MS 102.

In response to receiving the channel assignment request, BS 120 stops (229) the fourth timer T₃₀₃. When the fourth time period (229), as measured by fourth timer T₃₀₃, expires prior to BS 120 receiving a channel assignment request, BS 120 reconveys (228) the Paging Response to MSC 150, restarts timer T₃₀₃, and again awaits a receipt of a channel assignment request before expiration of a fourth time period (229). When BS 120 receives the channel assignment request prior to an expiration of the fourth time period (229), BS 120 and MS 102 set up (238) a wireless communication session via a traffic channel in forward link 106 in accordance with well known air interface call set up procedures, which procedures are described in detail in the IS-2000 standard.

Upon setting up a call with MS 102, BS 120 conveys (240) an A9-Setup-A8 message to PCF 130 via A9 interface 129 and starts a fifth timer, T_{A8-Setup}, that measures a fifth time period (241) with reference to timing reference unit 126. The A9-Setup-A8 message requests to establish an A8 connection between BS 120 and PCF 130 in A8 interface 128. In response to receiving the A9-Setup-A8 message, PCF 130 assigns an A8 connection in A8 interface 128 to a communication session with BS 120. PCF 140 then conveys (242) an A9-Connect-A8 message to BS 120 confirming the allocation of the A8 connection. When the fifth time period (241), as measured by fifth timer T_{A8-Setup}, expires prior to BS 120 receiving an A9-Connect-A8 message, BS 120 reconveys (240) the A9-Setup-A8 message to PCF 130, restarts fifth timer T_{A8-Setup}, and again awaits receipt of an A9-Connect-A8 message prior to expiration of a fifth time period (241).

When BS 120 receives the A9-Connect-A8 message prior to expiration of the fifth time period (241), BS 120 stops fifth timer T_{A8-Setup}. In addition, BS 120 conveys (244) a message, preferably an Assignment Complete message, to MSC 150 confirming the establishment of the A8 connection between PCF 140 and BS 120 and the traffic channel between BS 102 and MS 102. Infrastructure 110 and MS 102 then engage in a packet data communication session whereby the data packets received by infrastructure 110 from the network domain are transferred to the MS.

By providing MS 102 with information concerning the domain sourcing the data packets to infrastructure 110, the MS or the user of the MS is provided with the capability of determining whether to receive the data packets, activate a packet data service, or reject a reactivation attempt. The data packets are received by PDSN 140, which determines the domain sourcing the data packets to infrastructure 110 and the intended destination of the data packets and conveys an A11 message to PCF 130 that includes the domain and destination information, preferably NAI information. In response to receiving the domain and destination information from PDSN 140, PCF 130 in turn conveys an A9 message to BS 120 that includes the domain and destination information, preferably the NAI information. In one embodiment of the present invention, in response to receiving the domain and destination information from PCF 130, BS 120 pages MS 102 and assembles and conveys to MS 102 an air interface message that includes the domain information, preferably the NAI information.

In another embodiment of the present invention, in response to receiving the domain and destination information from PCF 130, BS 120 then assembles and conveys to MSC 150 a first A1 message, preferably a request for service, that includes the domain and destination information, preferably the NAI information. In response to receiving the request for service, MSC 150 conveys a second A1 message, preferably a modified Feature Notification message, to BS 102 that includes the domain and destination information. BS 120 pages MS 102 and either forwards the modified Feature Notification message to MS 102 or assembles and conveys to MS 102 an air interface message that is based on the modified Feature Notification message and that includes the domain information. By providing MS 102 with information concerning the domain sourcing the packet data received by infrastructure 110, the MS and/or user is able to determine whether to receive the data packets, activate a packet data service, or reject a reactivation attempt. The user is then able to control a degree to which the user is interrupted during an active communication session and is better able to control a quantity of data received by the MS and, thereby, his or her cost of wireless service.

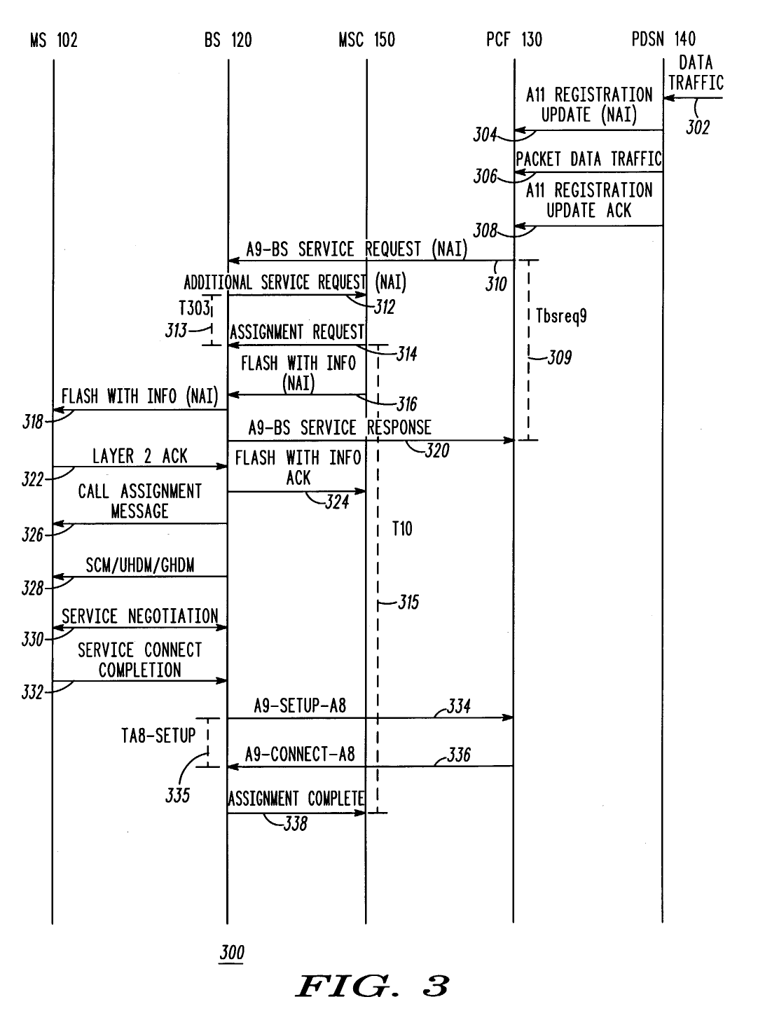

In another embodiment of the present invention, a “concurrent services” embodiment, MS 102 is actively engaged in a communication session, such as a voice session, at a time that infrastructure 110 receives data packets from a network domain to “push” to the MS. As a result, communication system 100 needs to establish an additional, concurrent, service for MS 102 in order to push the data packets to the MS. FIG. 3 is a signal flow diagram 300 illustrating a process performed by communication system 100, and in particular by infrastructure 110, in providing MS 102 with data packets received by the infrastructure from an external network in accordance with the “concurrent services” embodiment.

Signal flow diagram 300 begins when infrastructure 110, and in particular PDSN 140, receives (302) data packets from the network domain. The data packets are conveyed to infrastructure 110 in order that the infrastructure may “push” the data to MS 102. The data packets include information identifying the network domain sourcing the data to the infrastructure, such as the identifiers ‘.domainX,’ ‘.domainY,’ and ‘.domainZ.’ In response to receiving the data packets from the network domain, PDSN 140, preferably processor 142, assembles an A11 domain identification message and conveys (304) the message to PCF 130 via A11 interface 139. The A11 domain identification message identifies the domain sourcing the data packets received by the PDSN and further identifies the intended destination of the data packets. Preferably, the A11 domain identification message is an modified A11-Registration Update message, wherein an A11-Registration Update message is modified by processor 142 by embedding in the message a Network Access Identifier (NAI) that identifies the domain sourcing the data packets and the intended destination of the data packets. PDSN 140 also forwards (306) the data packets received from the external network to PCF 130 via an existing point-to-point protocol (PPP) connection and an A10/A11 connection associated with MS 102 for packet data service.

In response to receiving the A11 domain identification message, PCF 130 acknowledges the message by conveying (308) an acknowledgment to PDSN 140 via A11 interface 139. Preferably the acknowledgment comprises an A11-Registration Update Ack message. In addition, in response to receiving the A11 domain identification message, PCF 130, preferably processor 132, assembles and conveys (310) an A9 domain identification message to BS 120, preferably BSC 122, via A9 interface 129. Based on the A11 domain identification message, the A9 domain identification message includes information identifying the domain sourcing the data packets and further identifying the intended destination of the data packets. Preferably, the A9 domain identification message is an A9-BS Service Request message that is modified by processor 132 by embedding in the message the NAI information received from PSDN 140. When PCF 130 conveys the A9 domain identification message to BS 120, the PCF, in particular processor 132, also starts timer T_{bsreq9}, which timer measures a sixth time period (309) with reference to timing reference unit 136.

In response to receiving the A9 domain identification message, BS 120, preferably processor 123 of BSC 122, assembles and conveys (312) to MSC 150 via A1 interface 158 a request for additional, or supplemental, service message. The request for additional, or supplemental, service requests that an additional service be provided to MS 102 so that the packet data received by infrastructure 110 may be pushed to the MS. For example, if MS 102 is currently engaged in a voice call, the request for additional, or supplemental, service may request that packet data service also be provided to MS 102.

The request for additional, or supplemental, service message includes information on the domain sourcing the data packets and the intended destination of the data packets based on the A9 domain identification message received by the BS. Preferably, the first request for additional, or supplemental, service is an Additional Service Request message that is modified by processor 132 by embedding in the message the NAI information received from PCF 130. When BS 120 conveys the request for additional, or supplemental, service message to MSC 150, the BS, preferably BSC 122 and in particular processor 123, also starts timer T₃₀₃, which timer measures a seventh time period (313) with reference to timing reference unit 126.

In response to receiving the request for additional, or supplemental, service, MSC 150 requests (314) an assignment by BS 120 of a traffic channel in forward link 106 and an A8 connection in A8 interface 128 for a conveyance of the data packets received from the external network to MS 102. Preferably, MSC 150 requests the assignment of a traffic channel and an A8 connection by conveying an Assignment Request to BS 120. Upon conveying the Assignment Request to BS 120, MS 150, preferably processor 152, starts timer T₁₀, which timer measures an eighth time period (315) with reference to timing reference unit 156.

In addition to requesting assignment of a traffic channel and an A8 connection, MSC 150 conveys (316) to BS 120 a supplemental service request message that is assembled by processor 152 of the MSC and that includes information concerning the domain sourcing the data packets to infrastructure 110 and the destination of the data packets. Preferably the supplemental service request message comprises a first Flash with Information message that is modified by processor 152 by embedding in the message the domain and destination information, preferably the NAI information received by MSC 150 from BS 120. Upon receiving the information concerning the domain sourcing the data packets and the destination of the data packets from MSC 150, BS 120 in turn conveys (318) information concerning the domain sourcing the data packets and the destination of the data packets to MS 102.

In one embodiment of the present invention, BS 120 transmits the domain and destination information to MS 102 by forwarding the modified first Flash with Information message received by the BS from MSC 150. In another embodiment of the present invention, BS 120 transmits the domain and destination information to MS 102 in a modified second Flash with Information message. In the latter embodiment, processor 123 of BSC 122 assembles a second Flash with Information message and modifies the message by embedding information, preferably the NAI information received by BS 120 from MSC 150 or from PCF 130, identifying the domain sourcing the data packets to infrastructure 110 and the destination of the data packets.

When BS 120 receives the request from MSC 150 for an assignment of a traffic channel and an A8 connection and the seventh time period (313), as measured by timer T₃₀₃, has not expired, the BS stops (313) timer T₃₀₃ and acknowledges (320) receipt of the A9 domain identification message by conveying an acknowledgment to PCF 130 via A9 interface 129. Preferably the acknowledgment conveyed by BS 120 to PCF 130 comprises an A9-BS Service Response message. When the seventh time period (313), as measured by timer T₃₀₃, expires without BS 120 receiving the request from MSC 150 for an assignment of a traffic channel and an A8 connection, BS 120 reconveys A1 domain identification message to MSC 150, restarts timer T₃₀₃, and again awaits an receipt of an assignment request within a seventh time period (313). Upon receiving the A9 acknowledgment, PCF 130 stops (309) timer T_{bsreq9}. When the sixth time period (309), as measured by timer T_{bsreq9}, expires without PCF 130 receiving an acknowledgment of the A9 domain identification message, PCF 130 reconveys the A9 domain identification message to BS 120, restarts timer T_{bsreq9}, and again awaits reception of an acknowledgment of the A9 domain identification message before expiration of a first time period (309).

Similar to the process illustrated by signal flow diagram 200, in one embodiment of the present invention, in response to receiving the domain and destination information from BS 120, that is, the second modified Flash with Information message, MS 102 indicates to a user of the MS that infrastructure 110 has received data packets that are intended for the user and are from the domain identified by the message. The user of MS 102 can then indicate whether the user desires to receive the data packets. Also, similar to the process illustrated by signal flow diagram 200, in another embodiment of the present invention, the user of MS 102, upon activating the MS, may be presented with a menu of the services, that is, the domains, to which the user subscribes. The user may then input into the MS 102 the domains from which he desires to receive information and the domains from which he does not want to receive information.

When the user indicates a desire to receive the data packets from the domain identified by the second modified Flash with Information message, MS 102, in response to the user's indication and further in response to receipt of the BS Ack Order message from BS 120, acknowledges (322) receipt of the domain and destination information, that is, the second modified Flash with Information message, to BS 120. Preferably the MS acknowledges receipt of the second modified Flash with Information message by use of a Layer 2 Acknowledgment. In response to receiving the acknowledgment from MS 102, BS 120 acknowledges (324) receipt of the domain and destination information, that is, the first modified Flash with Information message, to MSC 150. Preferably, BS 120 acknowledges receipt of the first modified Flash with Information message by use of a Flash with Information Acknowledgment.

When the user fails to indicate a desire to receive the data packets, or indicates a desire to not receive the data packets, MS 102 does not acknowledge receipt of the domain and destination information, that is, the second modified Flash with Information message. When the eighth time period (315), as measured by timer T₁₀, expires prior to MSC 150 receiving an acknowledgment of the first modified Flash with Information message, the MSC may either terminate the process of providing the data packets to BS 120 or retransmit the first modified Flash with Information message to BS 120 and restart timer T₁₀. In the latter instance, after MSC 150 retransmits the first modified Flash with Information message to BS 120 a predetermined number of times without receiving an acknowledgment prior to an expiration of an eighth time period (315), the MSC terminates the process of providing the data packets to MS 102.

In another embodiment of the present invention, in response to receiving the domain and destination information from BS 120, that is, the second modified Flash with Information message, MS 102 may reject the attempt to establish an additional, concurrent, service for MS 102 in order to push the data packets to the MS. In the event that MS 102 rejects the attempt to establish the additional service, the MS may also initiate a teardown of any links established in regard to the additional service.

When BS 120 receives an acknowledgment of the domain and destination information from MS 102, in addition to conveying an acknowledgment to MSC 150, the BS also initiates a set up of a data connection with MS 102 in accordance with well known techniques. For example, in accordance with the IS-2000 standard, BS 120 conveys (326) a Call Assignment message to MS 102 over a traffic channel in forward link 106. The Call Assignment message causes MS 102 to initiate an establishment of a Call Control state machine. BS 120 also conveys (328) a Service Connect Message (SCM), a General Handoff Direction Message (GHDM), or a Universal Handoff Direction Message (UHDM), to MS 102 to invoke an establishment of a data connection over forward link 106. BS 120 may include the domain and destination information concerning the data packets received from the network domain, that is, the NAI information, in the SCM/GHDM/UHDM message.

MS 102 and BS 120 then engage in a negotiation (330) of services that will be supported by the MS and the BS in regard to the data connection in accordance with well known call set up negotiation techniques. Upon agreeing upon the services that will be supported in regard to the data connection, MS 102 conveys (332) a Service Connect Completion message to BS 120.

In response to receiving the Service Connect Completion message from MS 102, BS 120 conveys (334) an A9-Setup-A8 message to PCF 130 via A9 interface 129 and starts timer T_{A8-Setup}, which timer measures a ninth time period (335) with reference to timing reference unit 126. The A9-Setup-A8 message requests to establish an A8 connection between BS 120 and PCF 130 in A8 interface 128. In response to receiving the A9-Setup-A8 message, PCF 130 assigns an A8 connection in A8 interface 128 to a communication session with BS 120. PCF 140 then conveys (336) an A9-Connect-A8 message to BS 120 confirming the allocation of the A8 connection. When the ninth time period (335), as measured by timer T_{A8-Setup}, expires prior to BS 120 receiving an A9-Connect-A8 message, BS 120 reconveys (334) the A9-Setup-A8 message to PCF 130, restarts (335) timer T_{A8-setup}, and again awaits reception of an A9-Connect-A8 message prior to an expiration of a ninth time period (335).

When BS 120 receives the A9-Connect-A8 message prior to expiration of the ninth time period (335), BS 120 stops timer T_{A8-Setup}. In addition, BS 120 conveys (338) a message, preferably an Assignment Complete message, to MSC 150 confirming the establishment of the A8 connection between PCF 140 and BS 120 and the traffic channel between BS 102 and MS 102. Infrastructure 110 and MS 102 then engage in a packet data communication session whereby the data packets received by infrastructure 110 from the network domain are transferred to the MS.

All messages described above and in FIGS. 2 and 3, except for the A1, A9, and A11 domain identification messages, the additional service request message, and the supplemental service request messages, are described in detail in the TIA/EIA IS-2001 specifications, which specifications are available from the Telecommunications Industry Association and are hereby incorporated by reference herein. Furthermore, while A11 Registration Update, A9-BS Service Request, BS Service Request, A9-BS Service Response, Paging Request, Feature Notification, Additional Service Request, and Flash with Information messages are described in detail in the TIA/EIA IS-2001 specifications, such messages are modified by communication system 100 in order to convey information among the elements of system 100 that permits MS 102 to determine a domain and intended destination of a data packet received by infrastructure 110 from an external network.

In the concurrent services embodiment of the present invention, by providing MS 102 with information concerning the domain sourcing the data packets to infrastructure 110, the MS or the user of the MS is provided with the capability of determining whether to activate a packet data service when already engaged in a communication session. Similar to the single session embodiment, the data packets are received by PDSN 140, which determines the domain sourcing the data packets to infrastructure 110 and the intended destination of the data packets and conveys an A11 message to PCF 130 that includes the domain and destination information. In response to receiving the domain and destination information from PDSN 140, PCF 130 in turn conveys an A9 message to BS 120 that includes the domain and destination information. In one embodiment of the present invention, in response to receiving the domain and destination information from PCF 130, BS 120 then assembles and conveys to MS 102 an air interface message that includes the domain information, preferably the NAI information.

In another embodiment of the present invention, in response to receiving the domain and destination information from PCF 130, BS 120 assembles and conveys to MSC 150 a first A1 message, preferably a request for supplemental, or additional, services that includes the domain and destination information. In turn, MSC 150 then conveys a second A1 message, preferably a modified Flash with Information message, to BS 102 that includes the domain and destination information. BS 120 then either forwards to MS 102 the modified Flash with Information message, received from MSC 150 or assembles conveys to MS 102 an air interface message that is based on the modified Flash with Information message and that includes the domain information. Once again, by providing MS 102 with information concerning the domain sourcing the packet data received by infrastructure 110, the MS and/or user is able to determine whether to receive the data packets, activate a concurrent service, or reject an attempt to activate a concurrent service. The user is then able to control a degree to which the user is interrupted during an active communication session and is better able to control a quantity of data received by the MS and, thereby, his or her cost of wireless service.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for providing a data service selection to a user of a mobile station in a packet data communication system comprising steps of:
receiving packet data intended for the mobile station, wherein the data packet comprises information concerning a domain sourcing the packet data and an intended destination of the packet data;
conveying the domain information to the mobile station, wherein the domain information allows the mobile station to determine whether to receive the packet data.

2. The method of claim 1, wherein the step of receiving a data packet comprises a step of receiving, by a Packet Data Service Node (PDSN), the packet data intended for the mobile station and wherein the step of conveying the domain information to the mobile station comprises steps of:
conveying, by the PDSN, information concerning the domain sourcing the data packet and the intended destination of the packet data to a Packet Control Function (PCF);
in response to receiving domain and destination information from the PDSN, conveying, by the PCF, information concerning the domain sourcing the packet data and the intended destination of the packet data to a Base Station Subsystem (BS);
in response to receiving domain and destination information from the PCF, conveying, by the BS, information concerning the domain sourcing the packet data to the mobile station; and
wherein the domain information received by the mobile station allows the mobile station to determine whether to receive the packet data.

3. The method of claim 2, wherein the step of conveying, by the Base Station Subsystem (BS), information concerning the domain sourcing the information to the mobile station comprises steps of:
in response to receiving domain and destination information from the Packet Control Function (PCF), conveying, by the BS, information concerning the domain sourcing the information and the intended destination of the packet data to a Mobile Switching Center (MSC);
in response to receiving domain and destination information from the BS, conveying, by the MSC, information concerning the domain sourcing the information and the intended destination of the packet data to the BS;
in response to receiving domain and destination information from the MSC, conveying, by the BS, information concerning the domain sourcing the information to the mobile station.

4. The method of claim 3, wherein the step of conveying, by the Base Station Subsystem (BS), information concerning the domain sourcing the packet data and the intended destination of the packet data to a Mobile Switching Center (MSC) comprises a step of conveying, by the BS, a BS Service Request message in which is embedded a Network Access Identifier (NAI) that identifies the source of the packet data and the intended destination of the packet data.

5. The method of claim 3, wherein the step of conveying, by the Mobile Switching Center (MSC), information concerning the domain sourcing the information and the intended destination of the packet data to the Base Station Subsystem (BS) comprises a step of conveying, by the MSC to the BS, a Paging Request message in which is embedded a Network Access Identifier (NAI) that identifies the source of the packet data and the intended destination of the packet data.

6. The method of claim 3, wherein the step of conveying, by the Mobile Switching Center (MSC), information concerning the domain sourcing the information and the intended destination of the packet data to the Base Station Subsystem (BS) comprises a step of conveying, by the MSC to the BS, an A1 message in which is embedded a Network Access Identifier (NAI) that identifies the source of the packet data and the intended destination of the packet data.

7. The method of claim 3, wherein the step of conveying, by the Mobile Switching Center (MSC), information concerning the domain sourcing the information and the intended destination of the packet data to the Base Station Subsystem (BS) comprises a step of conveying, by the MSC to the BS, a Feature Notification message in which is embedded a Network Access Identifier (NAI) that identifies the source of the packet data and the intended destination of the packet data.

8. The method of claim 7, wherein the step of conveying, by the Base Station Subsystem (BS), information concerning the domain sourcing the information to the mobile station comprises a step of, in response to receiving domain and destination information from the Mobile Switching Center (MSC), forwarding, by the BS to the mobile station, the Feature Notification message received by the BS from the MSC.

9. The method of claim 3, wherein the step of receiving, by the Base Station Subsystem (BS) from the Mobile Switching Center (MSC), information concerning the network domain sourcing the packet data and the intended destination of the packet data comprises a step of receiving, by the BS from the MSC, a Flash with Information message in which is embedded information concerning the network domain sourcing the packet data and the intended destination of the packet data, and wherein the step of conveying, by the Base Station Subsystem (BS), information concerning the domain sourcing the information to the mobile station comprises a step of, in response to receiving domain and destination information from the Mobile Switching Center (MSC), forwarding, by the BS to the mobile station, the Flash with Information message received by the BS from the MSC.

10. The method of claim 2, wherein the step of conveying, by the Packet Data Service Node (PDSN), information concerning the domain sourcing the packet data and the intended destination of the packet data to a Packet Control Function (PCF) comprises a step of conveying, by the PDSN, an A11 domain identification message comprising information concerning the domain sourcing the packet data and the intended destination of the packet data.

11. The method of claim 10, wherein the A11 domain identification message comprises an A11 message generated by the PDSN in which is embedded a Network Access Identifier (NAI) that identifies the source of the packet data and the intended destination of the packet data.

12. The method of claim 10, wherein the A11 domain identification message comprises an A11-Registration Update message in which is embedded a Network Access Identifier (NAI) that identifies the source of the packet data and the intended destination of the packet data.

13. The method of claim 2, wherein the step of conveying, by the Packet Control Function (PCF), information concerning the domain sourcing the packet data and the intended destination of the packet data to a Base Station Subsystem (BS) comprises a step of conveying, by the PCF, an A9 domain identification message comprising information concerning the domain sourcing the packet data and the intended destination of the packet data.

14. The method of claim 13, wherein the A9 domain identification comprises an A9 message generated by the Packet Control Function and in which is embedded a Network Access Identifier (NAI) that identifies the source of the packet data and the intended destination of the packet data.

15. The method of claim 13, wherein the A9 domain identification message comprises an A9-BS Service Request message in which is embedded a Network Access Identifier (NAI) that identifies the source of the packet data and the intended destination of the packet data.

16. The method of claim 2, wherein the step of conveying, by the Packet Data Service Node (PDSN), the domain and destination information comprises steps of:
conveying, by the PDSN to a Packet Control Function (PCF), a message informing of the network domain sourcing the packet data and the intended destination of the packet data; and
conveying, by the PDSN to the PCF, the packet data.

17. The method of claim 2, wherein the step of conveying, by the Packet Control Function (PCF), the domain and destination information comprises steps of:
in response to receiving the domain and destination information from the Packet Data Service Node (PDSN), conveying, by the PCF to a Base Station Subsystem (BS), a message informing of the network domain sourcing the packet data and the intended destination of the packet data;
starting, by the PCF, a first timer;
receiving, from the BS, an acknowledgment of the message conveyed by the PCF to the BS informing of the network domain sourcing the packet data and the intended destination of the packet data; and
stopping, by the PCF, the first timer in response to receiving the acknowledgment.

18. The method of claim 2, further comprising a step of conveying, by the Base Station Subsystem (BS) to a Mobile Switching Center (MSC), a message informing of the network domain sourcing the packet data and the intended destination of the packet data.

19. The method of claim 18, further comprising steps of:
receiving, by the Base Station Subsystem (BS) from the Mobile Switching Center (MSC), an acknowledgment of the message conveyed by the BS to the MSC informing of the network domain sourcing the packet data and the intended destination of the packet data; and
requesting, by the MSC, that the BS page the mobile station.

20. The method of claim 19, further comprising steps of:
in response to conveying, by the Base Station Subsystem (BS) to the Mobile Switching Center (MSC), the message informing of the domain and the destination of the packet data, starting, by the BS, a second timer; and
in response to receiving, by the BS from the MSC, the an acknowledgment of the message informing of the domain and the destination of the packet data, stopping the second timer.

21. The method of claim 19, further comprising a step of conveying, by the Mobile Switching Center (MSC) to the Base Station Subsystem (BS), information concerning the network domain sourcing the packet data and the intended destination of the packet data.

22. The method of claim 19, further comprising steps of:
paging the mobile station by the Base Station Subsystem (BS);
conveying, by the Base Station Subsystem (BS) to the mobile station, information concerning the network domain sourcing the packet data.

23. The method of claim 22, further comprising a step of receiving, by the Base Station Subsystem (BS), an acknowledgment of the page of the mobile station, and wherein the BS conveys the domain information to the mobile station in response to receiving the acknowledgment of the page of the mobile station.

24. The method of claim 23, further comprising a step of acknowledging, by the Base Station Subsystem (BS) to the Mobile Switching Center (MSC), a successful page of the mobile station in response to receipt by the BS of the acknowledgment of the page of the mobile station.

25. The method of claim 24, further comprising steps of:
in response to requesting, by the Mobile Switching Center (MSC), that the Base Station Subsystem (BS) page the mobile station, starting, by the MSC a third timer; and
in response to receiving, by the MSC, an acknowledgment of a successful page of the mobile station, stopping, by the MSC, the third timer.

26. The method of claim 22, further comprising steps of:
receiving, by the Base Station Subsystem (BS), an acknowledgment of a receipt by the mobile station of the information concerning the network domain sourcing the packet data and the intended destination of the packet data; and
in response to receipt by the BS of the acknowledgment of a receipt by the mobile station of the domain and destination information, conveying, by the BS to the Mobile Switching Center (MSC), an acknowledgment of receipt by the BS of the information conveyed by the MSC concerning the network domain sourcing the packet data and the intended destination of the packet data.

27. The method of claim 26, further comprising steps of:
requesting, by the Mobile Switching Center (MSC), an assignment of a communication link from the PCF to the mobile station; and
in response to the request by the MSC to assign a communication link from the PCF to the mobile station, establishing a communication link from the PCF to the mobile station.

28. The method of claim 27, wherein the step of requesting a communication link comprises a step of conveying, by the Mobile Switching Center (MSC) to the Base Station Subsystem (BS), a request for an assignment of a communication link from the PCF to the mobile station, and wherein the method further comprises steps of:
in response to acknowledging, by the BS, a successful page of the mobile station, starting, by the BS, a fourth timer; and
in response to receiving, by the BS, the message requesting an assignment of a communication link from the PCF to the mobile station, stopping the fourth timer.

29. The method of claim 27, further comprising a step of conveying the packet data to the mobile station via the established communication link.

30. The method of claim 2, further comprising steps of:
conveying, by the Base Station Subsystem (BS) to a Mobile Switching Center (MSC), a supplemental service request that comprises a request for data service and that further comprises information concerning the network domain sourcing the packet data and the intended destination of the packet data; and
in response to conveying the supplemental service request to the MSC, receiving, by the BS, a message requesting an assignment of a communication link from the PCF to the mobile station.

31. The method of claim 30, further comprising a step of, in response to conveying the supplemental service request by the Base Station Subsystem (BS), receiving, by the BS from the Mobile Switching Center (MSC), information concerning the network domain sourcing the packet data and the intended destination of the packet data.

32. The method of claim 31, further comprising steps of:
in response to conveying the supplemental service request by the Base Station Subsystem (BS), starting, by the BS, a timer associated with the BS; and
in response to receiving, by the BS, a message requesting an assignment of a communication link, stopping the timer associated with the BS.

33. The method of claim 31, further comprising steps of:
receiving, by the Mobile Switching Center (MSC), the supplemental service request requesting supplemental service for the mobile station;
in response to receiving the supplemental service request, conveying, by the MSC, a message requesting an assignment of a communication link from the PCF to the mobile station;
receiving, by the BS, an acknowledgment from the mobile station of the information conveyed by the BS to the mobile station concerning the domain sourcing the packet data; and
upon receiving, by the BS, the acknowledgment from the mobile station of the receipt of the domain information, providing the requested supplemental service to the mobile station.

34. The method of claim 33, further comprising steps of:
in response to conveying, by the MSC, a message requesting an assignment of a communication link, starting, by the MSC, a timer associated with the MSC; and
in response to providing the requested supplemental service to the mobile station, stopping the timer associated with the MSC.

35. A method for providing a data service selection to a user of a mobile station in a packet data communication system comprising steps of:
receiving packet data intended for the mobile station, wherein the data packet comprises information concerning a domain sourcing the packet data and an intended destination of the packet data;
conveying the domain information to the mobile station, wherein the domain information allows the mobile station to determine whether to activate a packet data service.

36. The method of claim 35, wherein the step of receiving a data packet comprises a step of receiving, by a Packet Data Service Node (PDSN), the packet data intended for the mobile station and wherein the step of conveying the domain and destination information to the mobile station comprises steps of:
conveying, by the PDSN, information concerning the domain sourcing the data packet and the intended destination of the packet data to a Packet Control Function (PCF);
in response to receiving domain and destination information from the PDSN, conveying, by the PCF, information concerning the domain sourcing the packet data and the intended destination of the packet data to a Base Station Subsystem (BS);
in response to receiving domain and destination information from the PCF, conveying, by the BS, information concerning the domain sourcing the packet data to the mobile station; and
wherein the domain information received by the mobile station allows the mobile station to determine whether to receive the packet data.

37. A method for providing a data service selection to a user of a mobile station in a packet data communication system comprising steps of:
receiving packet data intended for the mobile station;
determining a domain sourcing the packet data based on a data path over which the packet data was received;
determining an intended destination of the packet data; and
conveying information concerning the domain sourcing the packet data to the mobile station, wherein the domain information allows the mobile station to determine whether to activate a packet data service.

38. The method of claim 37, wherein the step of receiving a data packet comprises a step of receiving, by a Packet Data Service Node (PDSN), the packet data intended for the mobile station and wherein the step of conveying the domain information to the mobile station comprises steps of:
conveying, by the PDSN, information concerning the domain sourcing the data packet and the intended destination of the packet data to a Packet Control Function (PCF);
in response to receiving domain and destination information from the PDSN, conveying, by the PCF, information concerning the domain sourcing the packet data and the intended destination of the packet data to a Base Station Subsystem (BS);
in response to receiving domain and destination information from the PCF, conveying, by the BS, information concerning the domain sourcing the packet data to the mobile station; and
wherein the domain information received by the mobile station allows the mobile station to determine whether to receive the packet data.

39. In a packet data communication system comprising an infrastructure that provides wireless communication services to at least one mobile station, wherein the infrastructure is capable of receiving packet data from a network domain that is intended for the at least one mobile station, a Packet Data Service Node (PDSN) capable of assembling an A11 domain identification message, wherein the A11 domain identification message comprises information identifying the domain sourcing the packet data to the infrastructure and further identifying the intended destination of the packet data.

40. The Packet Data Service Node (PDSN) of claim 39, wherein the PDSN assembles an A11 domain identification message by assembling an A11 message and embedding the in the A11 message a Network Access Identifier (NAI) that identifies the source of the packet data and the intended destination of the packet data.

41. The Packet Data Service Node (PDSN) of claim 39, wherein the PDSN assembles an A11 domain identification message by assembling an A11-Registration Update message and embedding, in the A11-Registration Update message, information identifying the domain sourcing the packet data to the infrastructure and further identifying the intended destination of the packet data

42. The Packet Data Service Node (PDSN) of claim 41, wherein the PDSN embeds domain and destination information in the A11-Registration Update message by embedding a Network Access Identifier (NAI) that identifies the domain sourcing of the packet data and the intended destination of the packet data.

43. In a packet data communication system comprising an infrastructure that provides wireless communication services to at least one mobile station, wherein the infrastructure is capable of receiving packet data from an external network that is intended for the at least one mobile station, a Packet Control Function (PCF) assembling an A9 domain identification message, wherein the A9 domain identification message comprises information identifying the domain sourcing the packet data to the infrastructure and further identifying the intended destination of the packet data.

44. The Packet Control Function (PCF) of claim 43, wherein the PCF assembles an A9 domain identification message by assembling an A9 message and embedding the in the A9 message a Network Access Identifier (NAT) that identifies the source of the packet data and the intended destination of the packet data.

45. The Packet Control Function (PCF) of claim 43, wherein the PCF assembles an A9 domain identification message by assembling an A9-BS Service Request message and embedding, in the A9-BS Service Request message, information identifying the domain sourcing the packet data to the infrastructure and further identifying the intended destination of the packet data.

46. The Packet Control Function (PCF) of claim 45, wherein the PCF embeds domain and destination information in the A9-BS Service Request message by embedding a Network Access Identifier (NAT) that identifies the domain sourcing of the packet data and the intended destination of the packet data.

47. In a packet data communication system comprising an infrastructure that provides wireless communication services to at least one mobile station, wherein the infrastructure is capable of receiving packet data from a network domain that is intended for the at least one mobile station, a Base Station Controller (BSC) capable of assembling an A1 domain identification message, wherein the A1 domain identification message comprises information identifying the domain sourcing the packet data to the infrastructure and further identifying the intended destination of the packet data.

48. The Base Station Controller (BSC) of claim 47, wherein the BSC assembles an A1 domain identification message by assembling an A1 message and embedding the in the A1 message a Network Access Identifier (NAI) that identifies the source of the packet data and the intended destination of the packet data.

49. The Base Station Controller (BSC) of claim 47, wherein the BSC assembles an A1 domain identification message by assembling a BS Service Request message and embedding, in the BS Service Request message, information identifying the domain sourcing the packet data to the infrastructure and further identifying the intended destination of the packet data

50. The Base Station Controller (BSC) of claim 49, wherein the BSC embeds domain and destination information in the BS Service Request message by embedding a Network Access Identifier (NAI) that identifies the domain sourcing the packet data and the intended destination of the packet data.

51. In a packet data communication system comprising an infrastructure that provides wireless communication services to at least one mobile station, wherein the infrastructure is capable of receiving packet data from a network domain that is intended for the at least one mobile station, a Base Station Controller (BSC) capable of assembling a domain and destination identification message for wireless transmission to a mobile station, wherein the domain and destination identification message comprises information identifying the domain sourcing the packet data to the infrastructure and further identifying the intended destination of the packet data and wherein the domain and destination identification message is utilized by the mobile station to determine whether to receive the packet data.

52. The Base Station Controller (BSC) of claim 51, wherein the BSC assembles an a domain and destination identification message for wireless transmission to a mobile station by assembling a Feature Notification message and embedding, in the Feature Notification message, information identifying the domain sourcing the packet data to the infrastructure and further identifying the intended destination of the packet data.

53. The Base Station Controller (BSC) of claim 52, wherein the BSC embeds domain and destination information in the Feature Notification message by embedding a Network Access Identifier (NAI) that identifies the domain sourcing the packet data and the intended destination of the packet data.

54. The Base Station Controller (BSC) of claim 51, wherein the BSC assembles an a domain and destination identification message for wireless transmission to a mobile station by assembling a Flash with Information message and embedding, in the Flash with Information message, information identifying the domain sourcing the packet data to the infrastructure and further identifying the intended destination of the packet data.

55. The Base Station Controller (BSC) of claim 54, wherein the BSC embeds domain and destination information in the Flash with Information message by embedding a Network Access Identifier (NAI) that identifies the domain sourcing the packet data and the intended destination of the packet data.

56. In a packet data communication system comprising an infrastructure that provides wireless communication services to at least one mobile station, wherein the infrastructure is capable of receiving packet data from a network domain that is intended for the at least one mobile station, a Mobile Switching Center (MSC) capable of assembling an A1 domain identification message, wherein the A1 domain identification message comprises information identifying the domain sourcing the packet data to the infrastructure and further identifying the intended destination of the packet data.

57. The Mobile Switching Center (MSC) of claim 56, wherein the MSC assembles an A1 domain identification message by assembling an A1 message and embedding in the A1 message a Network Access Identifier (NAI) that identifies the domain sourcing the packet data and the intended destination of the packet data.

58. The Mobile Switching Center (MSC) of claim 56, wherein the MSC assembles an A1 domain identification message by assembling a Feature Notification message and embedding, in the Feature Notification message, information identifying the domain sourcing the packet data to the infrastructure and further identifying the intended destination of the packet data.

59. The Mobile Switching Center (MSC) of claim 58, wherein the MSC embeds domain and destination information in the Feature Notification message by embedding a Network Access Identifier (NAI) that identifies the domain sourcing the packet data and the intended destination of the packet data.

60. The Mobile Switching Center (MSC) of claim 56, wherein the MSC assembles an A1 domain identification message by assembling a Flash with Information message and embedding, in the Flash with Information message, information identifying the domain sourcing the packet data to the infrastructure and further identifying the intended destination of the packet data.

61. The Mobile Switching Center (MSC) of claim 60, wherein the MSC embeds domain and destination information in the Flash with Information message by embedding a Network Access Identifier (NAI) that identifies the domain sourcing the packet data and the intended destination of the packet data.

62. In a packet data communication system comprising an infrastructure that provides wireless communication services to a mobile station, wherein the infrastructure is capable of receiving packet data from a network domain that is intended for the mobile station, a Base Station Controller (BSC) capable of assembling an message requesting additional services for the mobile station when the mobile station is engaged in a communication session, wherein the additional services request comprises a request for provision of a service to the mobile station that facilitates a transfer of the packet data to the mobile station and further comprises information identifying the domain sourcing the packet data to the infrastructure and the intended destination of the packet data.
